(19) United States
(12) Patent Application Publication
(10) Pub. No.: US 2014/0210144 A1
(43) Pub. Date: Jul. 31, 2014

(54) COMPOSITE DEGASSING TUBE

(71) Applicant: PYROTEK, Spokane Valley, WA (US)

(72) Inventors: Carlos Gibran Sanchez Torres, Apodaca (MX); Lee Andrew Nilson, Spokane Valley, WA (US)

(73) Assignee: PYROTEK, Spokane Valley, WA (US)

(21) Appl. No.: 13/755,867

(22) Filed: Jan. 31, 2013

(51) Int. Cl. F27D 3/16

(52) U.S. Cl. CPC F27D 3/16
USPC 266/207

(57) ABSTRACT

Disclosed is a degassing tube formed, at least partially, of a composite material and configured to degas molten metal. The degassing tube may include a supply tube configured to deliver gas received from a supply source to an outlet of the degassing tube, and a diffuser body coupled to the supply tube and formed, at least partially, of a composite material. In some embodiments, a combination of the composite material and a phosphate bonded refractory material may be used to form respective sections of the diffuser body. The composite material may include layers of a woven fiber reinforcing fabric embedded within a ceramic matrix. In some embodiments, the phosphate bonded refractory material is a castable monolithic refractory which chemically bonds to the composite material.

### FIELD OF THE INVENTION

The present invention relates generally to a degassing tube configured for use in metal foundries, and in particular, to a degassing tube, at least partially formed of composite material.

### DESCRIPTION OF THE RELATED ART

Processing molten aluminium often requires treating the molten aluminium to remove undesirable gases that naturally dissolve in the molten metal, especially at the temperatures under which the molten aluminium is typically processed. For instance, due to combustion of natural gas or oil in holding furnaces and/or exposure to ambient humidity, hydrogen dissolves significantly in molten aluminium. This dissolved hydrogen is subsequently released during solidification of the aluminium due to decreasing solubility of the hydrogen as the metal freezes which causes undesirable porosity defects in casted parts such as twisting and flaking in thin section extrusions, as well as blisters.

Introduction of inert, or chemically inactive, gas into molten aluminium has been known to effectively treat the molten metal by reducing the levels of unwanted, dissolved gas. For instance, a process of bubbling argon, nitrogen, or a similar inert gas, through molten aluminium is effective to remove dissolved hydrogen from the molten aluminium. As the bubbles of gas rise to the melt surface, dissolved hydrogen diffuses into the inert gas bubbles and is desorbed from the melt and released into the air above the surface of the melt. In addition, adding a small amount of chlorine (usually 0.5% or less) to the process gas breaks the bond between the aluminium and any non-wetted inclusions present in the melt, and helps to remove alkali metals, allowing the chlorine to react with the alkali metals and the rising gas bubbles to stick to the inclusions, floating the impurities to the melt surface. In other words, bubbling inert gas through molten metal is effective in treating the molten metal on multiple levels (i.e., ridding molten metal of absorbed gas and other impurities).

Gas injection devices, generally called “degassers,” are commonly used to supply process gas within a volume of molten metal. Degassers come in a variety of types, including those with rotating nozzles, and stationary degassers without moving or rotating parts. Conventional stationary degassers are at least partially made from single refractory materials such as ceramic, graphite and the like. These refractory materials are chosen for use in molten metal processing because they can withstand high temperatures and generally resist attack by liquid aluminium. However, these refractory materials are also fairly fragile and are prone to cracking and wear. As a consequence, single refractory materials may have limited lifetime.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Accordingly, disclosed herein is a degassing tube for treating molten metal (e.g., molten aluminium). In some embodiments, the degassing tube includes a supply tube configured to deliver gas received from a supply source to an outlet of the degassing tube, and a diffuser body coupled to the supply tube and formed, at least partially, of a composite material. In some embodiments, the diffuser body is formed entirely of the composite material, wherein the composite material includes layers of a woven fiber reinforcing fabric embedded within a ceramic matrix.

In yet other embodiments, the degassing tube is made up of at least two sections including a section toward a proximal end of the degassing tube that is near a gas supply source (“proximal section”) and another section toward a distal end of the degassing tube that is farther from the gas supply source (“distal section”). A portion of the diffuser body at the proximal section may be formed of the composite material, and another portion of the diffuser body at the distal section may be formed of a phosphate bonded refractory material.

Embodiments of the degassing tube disclosed herein are formed of material(s) with desirable properties which enable effective and efficient dispersion of gas within molten metal, as well as degassing tubes with longer life that are also lighter weight and more durable than conventional materials used for the manufacture of degassing tubes. The materials disclosed in embodiments herein are also not wetted by liquid metal, minimizing dross buildup.

Other features and advantages of the present invention will become apparent from the following description of the invention, which refers to the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a perspective view of an example degassing tube according to embodiments disclosed herein.

FIG. 2 illustrates an environmental side view of an example degassing tube according to embodiments disclosed herein as implemented within a furnace containing molten metal, as shown from a cross-section of the furnace.

FIG. 3 illustrates a side, cross-sectional view of an example degassing tube taken along the section line A-A of FIG. 1, according to embodiments disclosed herein.

### DETAILED DESCRIPTION

Disclosed herein is a degassing tube formed, at least partially, of a composite material. As used herein “degassing tube” means any device that performs degassing in molten metal. In some embodiments a combination of the composite material and a phosphate bonded refractory material may be used to form respective sections of a diffuser body of the degassing tube. The embodiments disclosed herein are described, by way of example and not limitation, with reference to degassing molten aluminium, which is used in casting aluminium. However, it is to be appreciated that the degassing tubes described herein may be used in other suitable applications, such as ingot casting with other metal types, or metal treatment in general, regardless of the application.

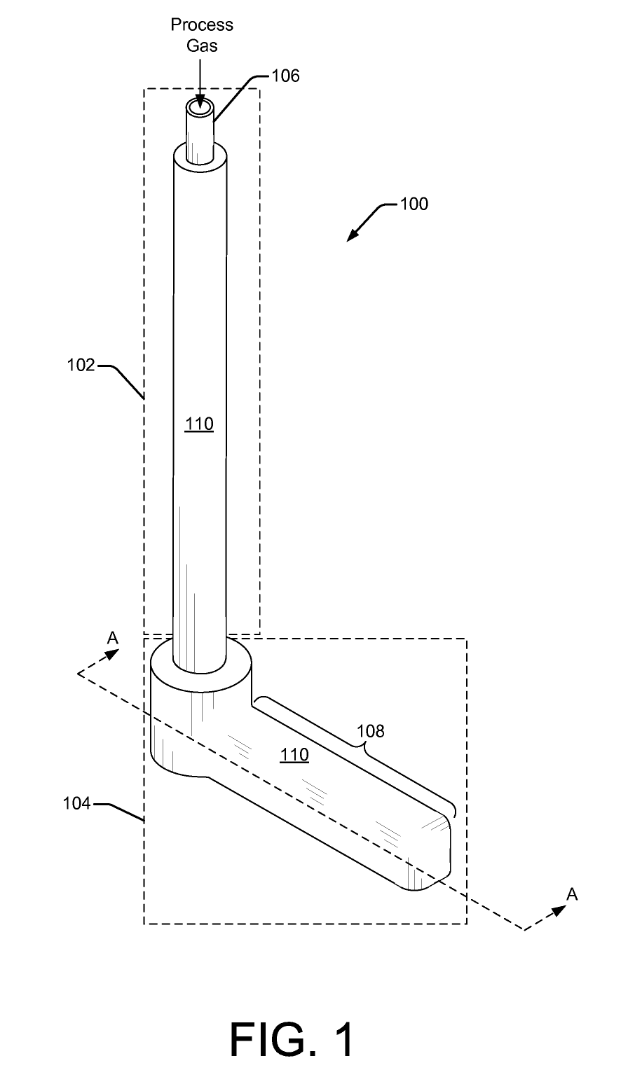

FIG. 1 illustrates a perspective view of an example degassing tube 100 according to embodiments disclosed herein. The degassing tube 100 may have any geometry suitable for degassing molten metal (e.g., molten aluminium). FIG. 1 shows the degassing tube 100 as having an L-shaped geometry. However, it is to be appreciated that the degassing tube 100 may be of other suitable geometries without changing the basic characteristics of the degassing tube 100. Regardless of the geometry, the degassing tube 100 may be thought of as comprising at least two main sections. A first section 102 is located toward a proximal end of the degassing tube that is near a gas supply source (hereinafter, “proximal section” 102), and a second section 104 is located toward a distal end of the degassing tube that is farther from the gas supply source (hereinafter, “distal section” 104). Accordingly, the proximal section 102 may be generally straight and vertical when arranged for use in degassing molten metal within a furnace or other suitable location. However, the proximal section 102, or a portion of the proximal section 102, may have some amount of curvature, depending on the environment in which the degassing tube 100 is situated. While FIG. 1 shows two sections 102 and 104, it is to be appreciated that the degassing tube 100 may be made up of any number of sections, or even a single unit.

As previously mentioned, the degassing tube 100 may be of any geometry that is suitable for degassing molten metal. Particularly, the distal section 104 may be generally perpendicular to the proximal section 102, thereby forming an L-shaped geometry for the degassing tube 100. However, the distal section 104 may take other suitable shapes/geometries, such as a generally perpendicular section that extends radially from the proximal section 102 in two directions, forming a “T-shaped” geometry of the degassing tube 100. Alternatively, the distal section 104 may be V-shaped, disc-shaped (i.e., circular), or bell-shaped, to name only a few shapes that are suitable for use in degassing molten metal. An advantage of the L-shape (shown in FIG. 1) or the T-shape geometry for the degassing tube 100 is that the bubbles of gas that are dispersed from the degassing tube 100 are at a significant distance away from the vertically oriented proximal section 102 of the degassing tube 100 and spread over a relatively large area such that coalescence of bubbles around the proximal section 102 is minimized as the bubbles rise through the molten metal.

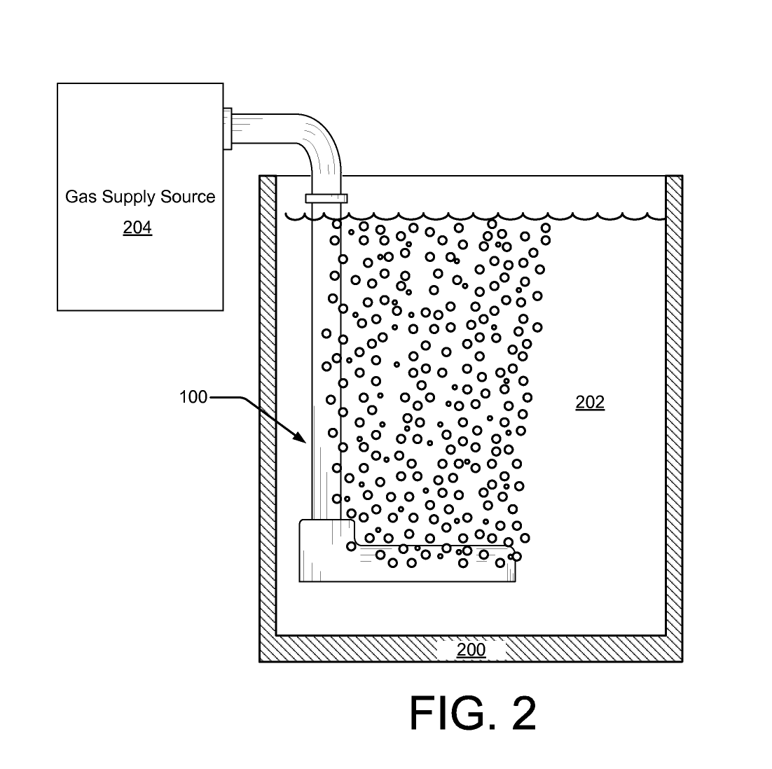

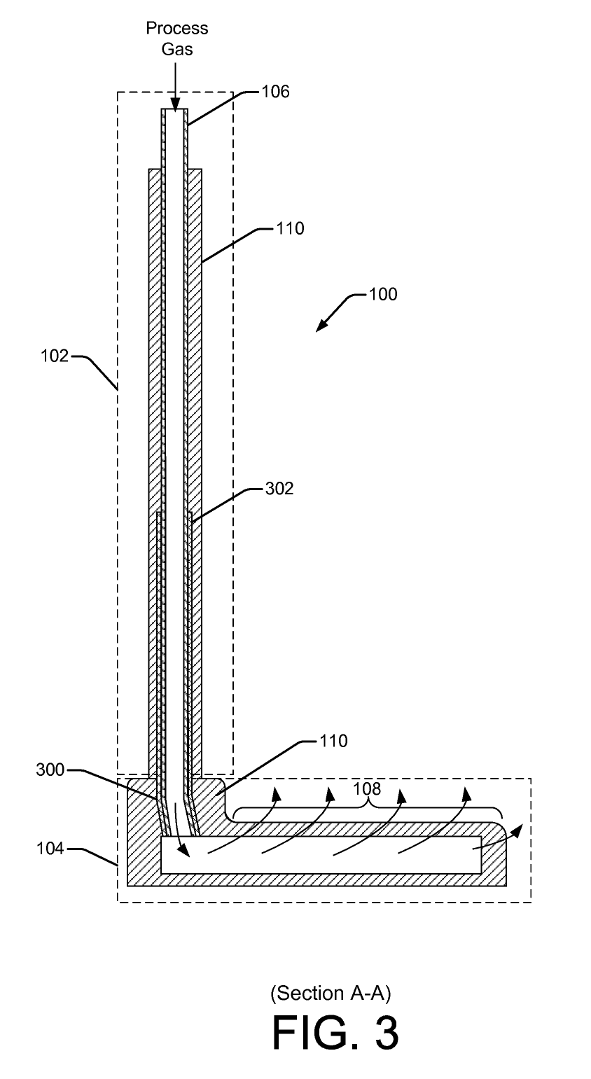

In some embodiments, the degassing tube 100 includes a supply tube 106 configured to deliver gas (“process gas”) that is received from a supply source to an outlet 108 of the degassing tube 100. The outlet 108 is configured to diffuse gas into the molten metal. In some embodiments, this is accomplished by virtue of permeability in the material used for a portion of the degassing tube 100, as described in more detail below. In this sense, the outlet 108 may be considered to include one or more exit points for the gas to exit/escape from a hollow cavity in the distal section 104 and into the volume of molten metal, as described in more detail with reference to FIGS. 2 and 3. The supply tube 106 may be made of steel, which is generally rigid, impermeable to gas, and therefore suitable for transporting gas from one location to another. However, it is to be appreciated that any suitable material may be used for the supply tube 106 so long as it generally has a higher melting point than aluminium and is impermeable to gas. The supply tube 106 is configured to be attached to piping or a similar structure such that the degassing tube 100 may be held in place during use.

In some embodiments, a diffuser body 110 of the degassing tube 100 may be coupled to the supply tube 106. For example, the supply tube 106 may be angled or curved at or near an end of the supply tube 106 that is near the distal section 104 of the degassing tube 100 such that separation of the diffuser body 100 and the supply tube 106 is prevented. As shown in FIG. 1, a portion of the diffuser body 110 is disposed over or around an outside of the supply tube 106 such that at least a portion of the diffuser body 110 acts as a shell surrounding the supply tube 106 and protecting the supply tube 106 from attack by the molten metal surrounding the degassing tube 100 when submerged in the melt.

The diffuser body 110 may generally be formed as a single, contiguous unit of a composite material. In this sense, each of the proximal section 102 and the distal section 104 may include a respective portion of the diffuser body 110, each portion being made of the composite material. In yet other embodiments, a portion of the diffuser body 110, such as a portion of the diffuser body 110 at the proximal section 102, is made of the composite material, while the remainder of the diffuser body 110 is made of a phosphate bonded refractory material, described in more detail below.

In some embodiments, the composite material may comprise a laminated composite material that includes layers of woven fiber (e.g., individual threads, a fabric, patches or segments of a fabric, chopped fibers, etc.) embedded within a ceramic matrix. The ceramic matrix material may comprise various ceramic materials, including fused silica, alumina, mullite, silicon carbide (SiC), silicon nitride, silicon aluminium oxy-nitride, zircon, magnesia, zirconia, graphite, calcium silicate, boron nitride (solid BN), and aluminium nitride (AlN), or a mixture of these materials. Preferably, the ceramic matrix material is calcium-based, and more preferably includes calcium silicate (wollastonite) and silica. Advantageously, the ceramic matrix material consists of approximately 60% by weight (wt) wollastonite and 40% by wt solid colloidal silica. The ceramic matrix material is permeable to gas to allow gas to diffuse into the molten metal.

In some embodiments, woven fiber acts as a reinforcing material and may comprise woven glass, or fiberglass, such as an electrical grade glass fiber or “E-glass.” Roughly between two to twenty-five layers of the reinforcing material/fabric may be used to construct portions of the diffuser body 110. In some embodiments, approximately ten layers are used to form at least a portion of the diffuser body 110. As used herein, “layers” may comprise a single piece of reinforcing fabric that is wrapped around the supply tube 106 a plurality of times to form the diffuser body 110, wherein each complete revolution constitutes a layer. The composite material is preferably a mouldable refractory composition as described in U.S. Pat. No. 5,880,046, the entire content of which is incorporated by reference herein.

In some embodiments, the diffuser body 110 may be made from the composite material. In the embodiments disclosed herein, when a portion of the diffuser body 110 is described as being made from the composite material, this means that generally all of the referenced portion is made of the composite material. In some embodiments, a protective coating may be applied to the diffuser body 110, such as a silicon carbide (SiC) paste.

The composite material which forms at least a portion of the diffuser body 110 offers advantages over conventional materials used for degassing tubes. For example, as compared to single refractory materials, the composite material allows for a thinner, smaller and lighter weight degassing tube 100 that is relatively strong and crack resistant, which provides for a longer life of the degassing tube 100. A lighter degassing tube 100 may be installed by a single installer without the use of machinery to assist in installation or replacement, and the downtime while installing/replacing the degassing tube 100 may be reduced.

A method of manufacturing the degassing tube 100 will now generally be described. First, the composite material is prepared by blending together the components of the composite material, for example as described in U.S. Pat. No. 5,880,046. The component materials may, for example, consist of approximately 60% by wt wollastonite and 40% by wt solid colloidal silica. These materials are blended together to form a slurry.

The degassing tube 100 is then constructed by laying pre-cut grades of woven fiber, such as woven electrical grade glass (E-glass) or high temperature glass cloth (HT-glass cloth), onto the supply tube 106. The slurry is then added by working the slurry into the woven fiber fabric to ensure full wetting of the woven fiber fabric. This is repeated to build up successive layers of reinforcing fabric and matrix material, until the desired thickness is achieved. Each layer typically has a thickness of approximately 1 millimeter (mm)

Once the degassing tube 100 is of a desired thickness, it is removed from the mould and machined to shape the outer surface of the degassing tube 100. The degassing tube 100 is then placed in a furnace to dry. After drying, the degassing tube 100 is subjected to final finishing processes, and a non-stick coating, such as boron nitride, may be applied.

In some embodiments, an elastomeric material, such as ceramic paper, may be deposited around all, or a portion, of the supply tube 106 prior to construction of the diffuser body 110 over the supply tube 106. The ceramic paper is configured to allow for displacement of the supply tube 106 due to thermal expansion caused by intense heat from the molten metal, thereby safeguarding the diffuser body 110 from cracking. The ceramic paper is shown with reference to FIG. 3, below.

In some embodiments, at least a portion of the diffuser body 110 is made from a phosphate bonded refractory material that is different than the composite material. Preferably, a portion of the diffuser body 110 at the distal section 104 of the degassing tube 100 is made of the phosphate bonded refractory material. Suitable phosphate bonded refractory materials include, but are not limited to, PyroFast (sold by Pyrotek, Inc., headquartered in Spokane, Wash.), Thermbond® Refractories (sold by Stellar Materials, Inc., headquartered in Boca Raton, Fla.), or any similar refractory castable material that is phosphate-bonded. In general, the phosphate bonded refractory material of the embodiments disclosed herein is a castable monolithic (i.e., unformed/unshaped) refractory. The phosphate bonded refractory material is permeable to gas to allow for diffusing gas at the outlet 108. These castable refractories are preferably alumina-based refractory castables that include a dry refractory component mixed with a liquid binder, or activator, comprising phosphoric acid. Upon application of the phosphate bonded refractory material within or onto a mold or part, the phosphate bonded refractory is given shape as it cures or sets.

The above described phosphate bonded refractory material is fast mixing and setting as compared to conventional refractory castables and is also thermal shock resistant and inherently resistant to corrosion by molten aluminium alloys. Notably, the phosphate bonded refractory material has been found herein to enable greater control over a bubble size of the gas that is dispersed from the diffuser outlet 108 through the use of various additives in the phosphate bonded refractory; a characteristic which is believed heretofore to have been unknown. Achieving an effective bubble pattern that distributes a large number of small gas bubbles throughout the volume of molten metal leads to increased efficiency of the metal treatment process known as degassing due to the high surface area-to-volume ratio which promotes diffusion of hydrogen into the gas bubbles. Thus, the phosphate bonded refractory is well suited for use in forming the diffuser body 110 at the distal section 104 of the degassing tube where the gas is to be dispersed into the molten metal.

To manufacture the degassing tube 100 using the phosphate bonded refractory for at least a portion of the diffuser body 110, such as a portion of the diffuser body 110 at the distal section 104, the phosphate bonded refractory may be poured into, or applied around, the preformed composite material of the diffuser body 110 at the proximal section 102 with the use of a mould to assist in the forming During this process, the phosphoric acid in the phosphate bonded refractory will penetrate the composite material and chemically react with calcium oxide (CaO) in the composite material to produce a chemical bond between the composite material and the phosphate bonded refractory. In this sense, the composite material and the phosphate bonded refractory are compatible and bond together at an interface with a high-strength junction. Additionally, extra adhesive bonding material such as mastic, cement, or similar adhesive that is generally resistant to molten aluminium, may be introduced to create an even stronger bond and enhance the gas tight seal between the composite material and the phosphate bonded refractory that make up the diffuser body 110, but it is to be appreciated that additional bonding material is purely optional for the embodiments disclosed herein.

In some embodiments, permeability in the diffuser body 110 at the distal section 104 is provided via polymer fibers during the manufacturing process. This permeability allows for dispersing the gas into the molten metal. For instance, polymer fibers are disposed within the diffuser body 110 at the distal section 104 before the material making up this portion of the diffuser body 110 sets or cures. After the material of the distal section 104 sets/cures, the polymer fibers may be burned away in a kiln. The space that the polymer fibers previously occupied creates pathways for the bubbles of gas to escape. A suitable sized fiber from 0.01 mm to 0.08 mm may be used to create optimal bubble sizes and patterns.

Turning now to FIG. 2, there is illustrated an environmental side view of an example degassing tube 100 according to embodiments disclosed herein as implemented within a furnace 200 containing molten metal 202, as shown from a cross-section of the furnace 200. In general, the furnace 200 is configured to hold a volume of molten metal 202, often called a molten metal “bath” or the “melt.” When implemented for treatment of the molten metal 202, the degassing tube 100 is configured to sit along a side wall of the furnace 200, such as a holding furnace, as shown in FIG. 2. The degassing tube 100 is to be positioned away from where the molten metal 202 is poured into the furnace 200 to refill the furnace 200 such that the degassing tube 100 is protected from adverse effects of pouring the molten metal 200 close to the degassing tube 100 which may damage the degassing tube 100. The degassing tube 100 may form part of a degassing assembly by virtue of being permanently, or removably, coupled to a piping structure, or hose(s), above the furnace 200. This acts to hold the degassing assembly in place. The piping may be connected to a gas supply source 204 configured to supply inert gas, such as argon, nitrogen, chlorine, freon, or the like, to the degassing tube 100 for dispersion within the volume of molten metal 202. Optionally, legs or spacers may be utilized at or near the distal section 104 of the degassing tube 100 such that the degassing tube 100 may be anchored to the furnace 200 and held more firmly in position. In this scenario, the degassing tube 100 may have a particular geometric shape in order to accommodate the legs or spacers and to facilitate such anchoring. Furthermore, it is to be appreciated that the degassing tube 100 may be suitably positioned anywhere in a metal processing facility, such as in-line between the furnace 200 and a casting station downstream in the metal processing facility. In some instances, the degassing tube 100 may be positioned as close as practicable to a downstream casting station.

As shown in FIG. 2, during operation, the degassing assembly (degasser), including the degassing tube 100, works to disperse and distribute the inert gas supplied by the gas supply source 204 throughout the molten metal 202. As the bubbles of gas exit the degassing tube 100 at the outlet 108, the bubbles rise through the molten metal 202, removing unwanted, dissolved gas and other impurities and inclusions from the molten metal 202.

FIG. 3 illustrates a side, cross-sectional view of an example degassing tube 100 taken along the section line A-A shown in FIG. 1, according to embodiments disclosed herein. As shown in FIG. 3, as gas is supplied to the degassing tube 100, the gas travels within the supply tube 106 toward the outlet 108 of the degassing tube 100 where it is dispersed within the molten metal 202. In some embodiments, the outlet 108 comprises a random interconnection of conduits in the material of the diffuser body 110 at the distal section 104 of the degassing tube 100. As shown in FIG. 3, the diffuser body 110 of the degassing tube 100 may be coupled to the supply tube 106. For example, the supply tube 106 may have an angled portion 300 at or near an end of the supply tube 106 that is near the distal section 104 of the degassing tube 100 such that separation of the diffuser body 100 and the supply tube 106 is prevented.

In some embodiments, the degassing tube 100 may further include ceramic paper 302, or a similar elastomeric material, which may be layered or wrapped around the supply tube 106 during manufacture of the degassing tube 100. As mentioned above, the ceramic paper 302 allows for the supply tube 106 to expand under a change in temperature due to thermal expansion of the material making up the supply tube 106, such as steel. The ceramic paper 302 creates a tolerance for the supply tube 106 to expand such that it minimizes a force applied onto the diffuser body 110 which may cause cracking of the diffuser body 110 material. This is especially useful when at least a portion of the supply tube 106 is curved. Some or all of the supply tube 106 may be wrapped with one or more layers of the ceramic paper 302.

In some embodiments, tape may be applied over the ends of the ceramic paper 302 where it ends on the supply tube 106 to compress the ceramic paper 302 and to reduce gas leakage.

### CONCLUSION

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A degassing tube comprising:
a supply tube configured to deliver gas from a supply source to an outlet of the degassing tube; and
a diffuser body coupled to the supply tube and formed, at least partially, of a composite material comprising a reinforcing fiber within a ceramic matrix, the diffuser body configured to diffuse the gas within molten metal at the outlet of the degassing tube.

2. The degassing tube of claim 1, wherein the reinforcing fiber is part of a woven fiber reinforcing fabric embedded within the ceramic matrix.

3. The degassing tube of claim 2, wherein the woven fiber reinforcing fabric comprises a glass and the ceramic matrix comprises calcium silicate and silica.

4. The degassing tube of claim 1, wherein the outlet comprises an interconnection of conduits in the composite material at a distal section of the degassing tube.

5. The degassing tube of claim 1, wherein the diffuser body is formed of a combination of the composite material for a proximal section of the degassing tube and a phosphate bonded refractory material for a distal section of the degassing tube.

6. The degassing tube of claim 5, wherein the phosphate bonded refractory material is a castable monolithic refractory.

7. The degassing tube of claim 5, wherein the phosphate bonded refractory material is alumina-based.

8. The degassing tube of claim 5, wherein a portion of the diffuser body at the distal section is chemically bonded to another portion of the diffuser body at the proximal section.

9. The degassing tube of claim 1, wherein a geometry of the degassing tube is at least one of an L-shape or a T-shape.

10. A degassing tube comprising:
a supply tube configured to deliver gas from a supply source to an outlet of the degassing tube; and
a diffuser body coupled to the supply tube and configured to diffuse the gas within molten metal at the outlet of the degassing tube, the diffuser body:
being formed, at least partially, of a composite material at a proximal section of the degassing tube, and
being formed, at least partially, of a refractory material at a distal section of the degassing tube.

11. The degassing tube of claim 10, wherein the refractory material comprises a phosphate bonded refractory material.

12. The degassing tube of claim 10, further comprising an elastomeric material disposed around the supply tube.

13. The degassing tube of claim 10, wherein the composite material includes multiple layers of a woven fiber reinforcing fabric embedded within a ceramic matrix.

14. The degassing tube of claim 13, wherein the ceramic matrix is calcium silicate-based.

15. The degassing tube of claim 13, wherein the ceramic matrix is selected from the group consisting of fused silica, alumina mullite, silicon carbide, silicon nitride, silicon aluminium oxy-nitride, zircon, magnesia, zirconia, graphite, calcium silicate, boron nitride, aluminium nitride, and mixtures of these materials.

16. The degassing tube of claim 13, wherein the supply tube is disposed under the multiple layers of the woven fiber reinforcing fabric.

17. The degassing tube of claim 11, wherein the phosphate bonded refractory material is alumina-based and includes phosphoric acid.

18. The degassing tube of claim 11, wherein a portion of the diffuser body at the distal section is chemically bonded to another portion of the diffuser body at the proximal section.

19. The degassing tube of claim 11, wherein the phosphate bonded refractory material is a castable monolithic refractory.

20. A degassing tube comprising:
means for delivering gas from a supply source to an outlet of the degassing tube; and
means for diffusing the gas within molten metal at the outlet of the degassing tube, the means for diffusing being formed, at least partially, of a composite material comprising a reinforcing fiber within a ceramic matrix.
